(19) United States
(12) Patent Application Publication
(10) Pub. No.: US 2018/0133865 A1
(43) Pub. Date: May 17, 2018

(54) Method For Cleaning A Compressor Using Dry Ice

(71) Applicant: MAN DIESEL & TURBO SE, Augsburg (DE)

(72) Inventors: Kolja METZ, Berlin (DE); Christian WACKER, Berlin (DE)

(21) Appl. No.: 15/572,723

(22) PCT Filed: May 3, 2016
(86) PCT No.: PCT/EP2016/059945

§ 371 Date: Nov. 8, 2017

(30) Foreign Application Priority Data
May 9, 2015 (DE) 102015006082.1

(51) Int. Cl. B24C 1/00; B08B 7/00; B24C 1/08; B24C 3/32

(52) U.S. Cl. CPC B24C 1/003; B24C 3/327; B24C 1/086; B08B 7/00

(57) ABSTRACT

A method for cleaning a compressor having at least one compressor stage and serving to compress an operating medium. In at least one compressor stage of the compressor, during the compression operation, dry ice, or solid CO₂, is used for the operating medium for abrasive cleaning of assemblies of the respective compressor stage to be cleaned.

### CROSS REFERENCE TO RELATED APPLICATIONS

This is a U.S. national stage of application No. PCT/EP2016/059945, filed on May 3, 2016. Priority is claimed on German Application No. DE102015006082.1, filed May 9, 2015, the content of which is incorporated here by reference.

### BACKGROUND OF THE INVENTION

### 1. Field of the Invention

The invention relates to a method for cleaning a compressor.

### 2. Description of the Prior Art

It is known from practice to clean a compressor, comprising at least one compressor stage and serving for compressing a working medium, wherein for cleaning according to the practice a washing liquid is introduced into at least one compressor stage of the compressor for cleaning the same, for example with the help of spray nozzles. When cleaning takes place during the compression operation, large quantities of washing liquid also enter the compression process, which then have to be separated again from the working medium. This is expensive. Furthermore, insoluble contaminations cannot be removed. There is a need for a method for cleaning a compressor with the help of which the above disadvantages can be avoided, i.e. with the help of which the separating of washing liquid from the working medium becomes superfluous, and with the help of which even insoluble contaminations can be removed.

### SUMMARY OF THE INVENTION

Starting out from this, one aspect of the present invention is based on the object of creating a new type of method for cleaning a compressor.

This object is solved through a method for cleaning a compressor. According to one aspect of the invention, dry ice, i.e. solid CO₂, is utilised in at least one compressor stage of the compressor during the compression operation for the working medium for the abrasive cleaning of assemblies of the respective compressor stage to be cleaned.

The invention utilises dry ice, i.e. solid CO₂, for cleaning a respective compressor stage of the compressor. By way of the abrasive action of the dry ice, severe contaminations, even insoluble contaminations, can be reliably removed. Since the dry ice subsequently sublimates it is not required to remove washing liquid from the compressed working medium via a separation process.

The dry ice is preferentially introduced into the respective compressor stage to be cleaned via a carrier gas, wherein the dry ice via the carrier gas is directed at the respective compressor stage to be cleaned. Liquid CO₂ can also be introduced into the respective compressor stage with a pressure that is above the process pressure in the respective compressor stage, which through isenthalpic expansion is converted into dry ice and carrier gas in the respective compressor stage, wherein the dry ice for the abrasive cleaning is directed via the carrier gas at assemblies of the respective compressor stage to be cleaned.

According to an advantageous further development of the invention, dry ice extracted from the working medium internally or during the compression operation of the compressor is used for cleaning at least one compressor stage and carrier gas extracted internally or during the compression operation of the compressor from the working medium is used for cleaning the respective compressor stage. This further development of the invention is employed in particular when the compressor serves for compressing CO₂. In this case, the dry ice and the carrier gas for introducing the dry ice into the compressor stage to be cleaned can be entirely extracted internally, so that neither externally obtained dry ice nor externally obtained carrier gas is needed.

According to a second advantageous further development of the invention, dry ice obtained externally or outside the compression operation of the compressor not from the working medium is used for cleaning at least one compressor stage and/or carrier gas obtained externally or outside the compression operation of the compressor not from the working medium, preferentially externally obtained dry ice and carrier gas internally extracted from the compressed working medium or alternatively externally obtained dry ice and externally obtained carrier gas is used for cleaning the respective compressor stage. This further development of the invention, in which externally obtained dry ice and/or externally obtained carrier gas is used for cleaning the respective compressor stage allows an effective cleaning of each compressor stage of the compressor regardless of the pressure conditions of the working medium.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1 is a block diagram for illustrating a method for cleaning a compressor;

FIG. 2 is a block diagram for illustrating a method for cleaning a compressor;

FIG. 3 is a block diagram for illustrating a method for cleaning a compressor;

FIG. 4 is a block diagram for illustrating a method for cleaning a compressor; and

FIG. 5 is a block diagram for illustrating a method for cleaning a compressor.

### DETAILED DESCRIPTION OF THE PRESENTLY PREFERRED EMBODIMENTS

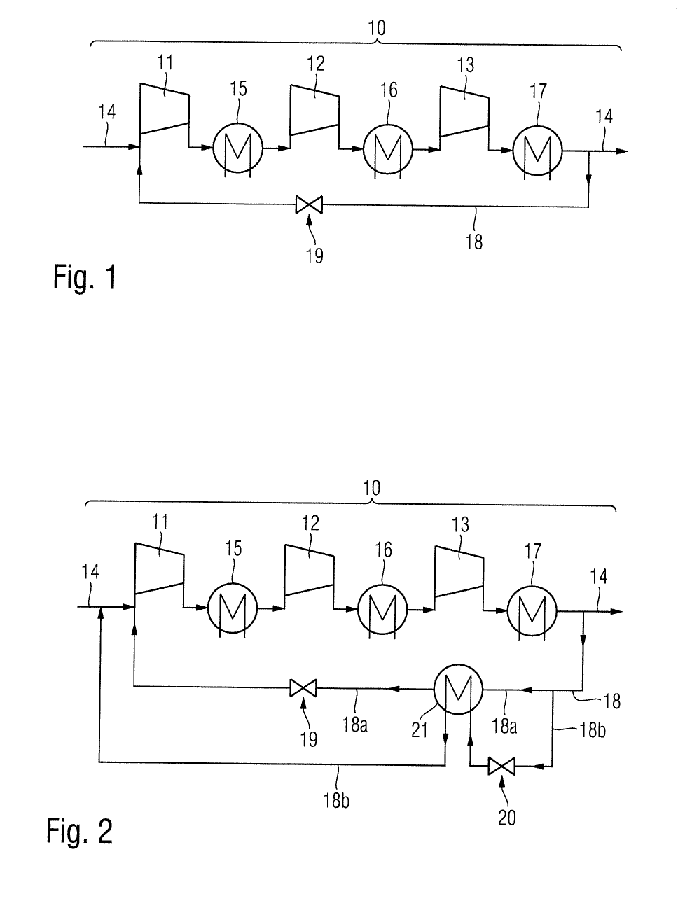

FIG. 1 shows an exemplary embodiment of a compressor 10 with three compressor stages 11, 12, and 13, wherein in the compressor stages 11, 12, and 13 a working medium 14 is gradually compressed. Downstream of each compressor stage 11, 12, 13 a cooler 15, 16, 17 is arranged to cool the working medium 14, which has been partly compressed in the respective upstream compressor stage 11, 12, 13.

In FIG. 1, the front-most compressor stage 11 of the compressor 10 is cleaned during the compression operation for the working medium 14, namely with dry ice, i.e. with solid CO₂, which is introduced via a carrier gas into the compressor stage 11. By way of the carrier gas, the dry ice is directed at assemblies of the compressor stage 11 to be cleaned for abrasively cleaning the same.

In the exemplary embodiment of FIG. 1, dry ice extracted internally and carrier gas extracted internally is used for cleaning the compressor stage 11. Here, the compressor 10 of FIG. 1 serves for compressing working medium in the form of CO₂, wherein downstream of the rear-most or last compressor stage 13 supercritically compressed CO₂ is present. This supercritically compressed CO₂ is cooled down in the cooler 17, wherein downstream of the cooler 17 CO₂ is present, which can be liquid but also supercritical. From the working medium 14, a part is conducted via a recirculation line 18, in which an expansion valve 19 is arranged. In the expansion valve 19, an expansion of the CO₂ takes place for the further cooling of the same. If appropriate, the CO₂ is already isenthalpically expanded so far in the region of the expansion valve 19 or alternatively only downstream of the expansion valve 19 in the region of the compressor stage 11 to convert liquid CO₂ into solid CO₂, i.e. dry ice, and gaseous CO₂, i.e. carrier gas. Accordingly, from the compressed working medium 14 a part is branched off in order to obtain from the same by cooling and expansion on the one hand gaseous CO₂ as internally extracted carrier gas and on the other hand solid CO₂ as internally extracted dry ice and to utilise this for cleaning the compressor stage 11.

A further development of the exemplary embodiment of FIG. 1 is shown by FIG. 2, wherein in the exemplary embodiment of FIG. 2 the liquid CO₂ branched off into the recirculation line 18 is divided into two part flows 18a, 18b. The part flow 18a is converted by cooling and expansion into solid CO₂ and gaseous CO₂ for providing internally extracted dry ice and internally extracted carrier gas. The second part flow 18b is conducted via a further expansion valve 20 for the expansion and cooling of the same, in order to further cool the first part flow 18a via this second part flow 18b using a cooler 21 positioned upstream of the expansion valve 19 prior to the conversion into solid CO₂ and gaseous CO₂. By way of this, compared with FIG. 1, the formation of internally extracted dry ice can be improved. The second part flow 18b utilised for cooling the first part flow 18a according to FIG. 2 is recirculated into or admixed to the working medium 14 upstream of the first compressor stage 11.

As already explained, the exemplary embodiments of FIGS. 1 and 2 are in particular employed with a compressor that compresses CO₂ as working medium.

In FIGS. 1 and 2, dry ice extracted internally or during the compression operation of the compressor from the working medium compressed in a higher or in a high-pressure side compressor stage and carrier gas extracted internally or during the compression operation of the compressor from the working medium compressed in the higher or in the high-pressure side compressor stage are utilised in each case for cleaning a lower or low-pressure side compressor stage. Dependent on the process pressures in the compressor stages of the compressor, only a part quantity of the compressor stage can be cleaned with dry ice extracted internally or during the compression operation of the compressor in the versions of FIGS. 1 and 2.

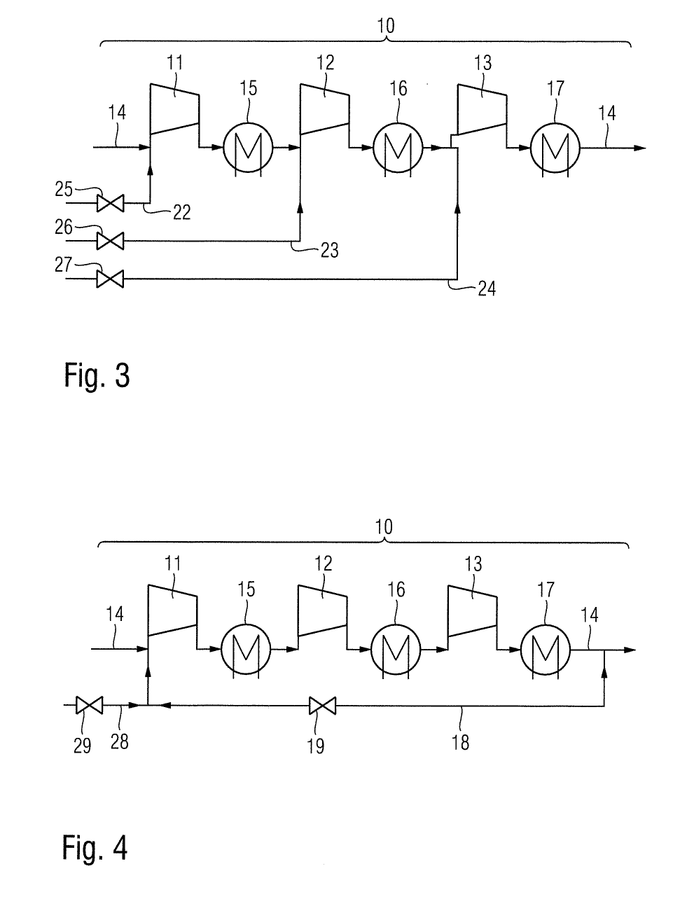

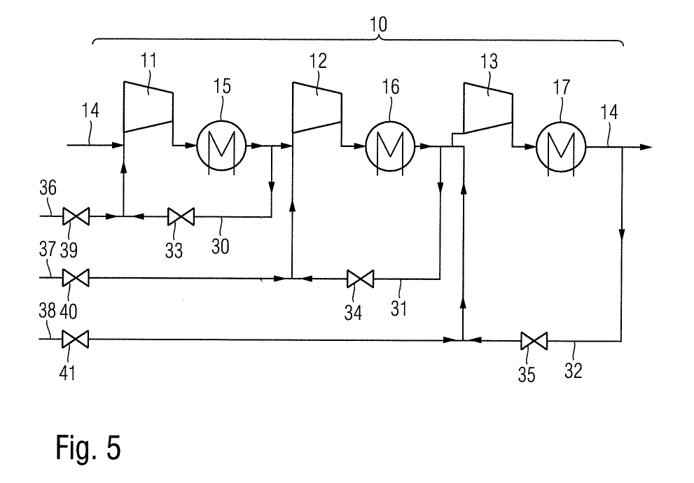

FIGS. 3 to 5 show further configurations of the invention, again on the example of a compressor 10 with the three compressor stages 11, 12, and 13 and coolers 15 to 17 connected downstream of the compressor stages 11 to 13. In the versions of FIGS. 3 and 5, all compressor stages can be cleaned with externally obtained dry ice.

FIG. 3 shows a form of the invention, in which assemblies of each of the compressor stages 11, 12, 13 are abrasively cleaned with the help of dry ice, wherein the dry ice is introduced into the respective compressor stage 11, 12, 13 via a carrier gas. In FIG. 3, carrier gas obtained externally or outside the compression operation of the compressor and not carrier gas extracted from the working medium compressed by the compressor and dry ice obtained externally or outside the compression operation of the compressor and not extracted from the working medium compressed by the compressor is used. Accordingly, in FIG. 3, a line 22, 23, 24 in which a valve 25, 26, and 27 respectively is integrated in each case leads to each of the compressor stages 11, 12, 13 to be cleaned. Dependent on the opening position of the valve 25, 26, 27, dry ice kept ready externally can be conducted via the respective line 22, 23, 24 by way of carrier gas kept ready externally can be conducted in the direction of the respective compressor stage 11, 12, 13 to be cleaned.

As carrier gas, a gas can be taken for example that corresponds to the compressed working medium 14 (but not necessarily so).

A further configuration of the invention is shown by FIG. 4, wherein in the version of FIG. 4 dry ice obtained externally or outside the compression operation of the compressor and not extracted from the working medium compressed by the compressor but carrier gas extracted internally or during the compression operation of the compressor from the compressed working medium is conducted to the compressor stage 11 for cleaning. For providing the internally extracted carrier gas, a part is branched off from the compressed working medium 14 via the recirculation line 18 and expanded in the expansion valve 19.

This expanded working medium, which provides the internally extracted carrier gas, is mixed in FIG. 4 with dry ice obtained externally or outside the compression operation of the compressor and not extracted from the working medium compressed in the compressor, which is provided via the line 28 dependent on the opening position of a valve 29 integrated in the line 28. The internally extracted carrier gas is mixed with the externally provided dry ice and then conducted for the cleaning of the compressor stage 11.

A further configuration of the invention is shown by FIG. 5. In FIG. 5, each compressor stage 11, 12, 13 is again cleaned. Carrier gas required for this purpose is branched off from the respective working medium to be compressed via recirculation lines 30, 31, 32 and extracted through expansion of the same in the region of an expansion valve 33, 34, and 35 respectively assigned to the respective recirculation lines 30, 31, 32. Accordingly, the carrier gas needed in the compressor stage 11 is branched off downstream of the cooler 15 and conducted via the recirculation line 30 and the expansion valve 33 assigned to the recirculation line 30. The carrier gas, which is needed in the region of the compressor stage 12, is branched off in the region of the recirculation line 31 downstream of the cooler 16 connected downstream of said compressor stage 12 and in the region of the expansion valve 34 converted into carrier gas. Carrier gas, which is needed for cleaning the compressor stage, 13 is branched off via the recirculation line 22 downstream of the cooler 17 connected downstream of the compressor stage 13 and in the region of the expansion valve 35 assigned to this recirculation line 32 converted into carrier gas. Accordingly, in the region of each compressor stage 11, 12, 13, internally extracted carrier gas is utilised, which is extracted through an expansion of the working medium, partly compressed in the respective compressor stage 11, to be cleaned in the region of the respective expansion valve 33, 34, and 35 respectively. The respective carrier gas is mixed with externally provided dry ice, which can be conducted via the lines 36, 37, 38 and the valves 39, 40, 41 assigned to these lines 36, 37, 38 in the direction of the respective compressor stage 11, 12, 13. The respective dry ice is mixed with the respective carrier gas and then conducted to the respective compressor stage 11, 12, 13 for cleaning the same.

Accordingly, according to the invention, dry ice, solid CO₂ is used for cleaning a compressor stage of a compressor 10, which is preferentially introduced into the respective compressor stage via a carrier gas. The dry ice can be internally extracted dry ice or externally provided dry ice. Likewise, the carrier gas can be internally extracted carrier gas or externally provided carrier gas.

In the case of compressors that serve for compressing CO₂, both the carrier gas and also the dry ice can be extracted through isenthalpic expansion of liquid CO₂ from a high pressure to a low pressure. The proportion of the extracted solid CO₂, i.e. the proportion of the extracted dry ice in this case depends on the pressure and the temperature of the liquid CO₂, wherein by cooling the liquid CO₂ prior to the expansion of the same the proportion of the extractable dry ice can be increased (see above version of FIG. 2).

The solid particles of the dry ice are transported by the carrier gas and directed onto the assemblies of the respective compressor stage to be cleaned with high velocity. In the process, the solid particles of dry ice strike contaminations in the region of the assemblies of the respective compressor stage and detach the same by way of an abrasive action. During the further process operation, the dry ice evaporates or sublimates so that no washing medium has to be separated out.

The invention can be employed with all types of compressors for example radial compressors and axial compressors. With the invention, a particularly advantageous and effective cleaning of a compressor is possible.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A method for cleaning a compressor, which comprises at least one compressor stage, comprising:
compressing a working medium by the compressor;
using dry ice (solid CO₂) to abrasively clean of assemblies of a respective compressor stage of the compressor to be cleaned, during the compression of the working medium.

11. The method according to claim 10, wherein the dry ice is introduced into the respective compressor stage via a carrier gas, wherein the dry ice via the carrier gas is directed on assemblies of the respective compressor stage to be cleaned by the abrasive cleaning.

12. The method according to claim 10, further comprising:
introducing liquid CO₂ into the respective compressor stage; and
converting the liquid CO₂ into dry ice and carrier gas through isenthalpic expansion; and
directing the dry ice via the carrier gas at assemblies of the respective compressor stage to be cleaned.

13. The method according to claims 11, wherein for cleaning the at least one compressor stage the dry ice used for cleaning the respective compressor stage is extracted one of internally and during the compression operation of the compressor and the carrier gas is extracted one of internally and during the compression operation of the compressor is.

14. The method according to claim 13,
wherein the compressor is configured to compress CO₂,
wherein downstream of a high-pressure side compressor stage supercritically
compressed CO₂ is initially liquefied and subsequently converted into solid CO₂ and gaseous CO₂, and
wherein the gaseous CO₂ extracted and used as carrier gas and the solid CO₂ is extracted and used as dry ice for cleaning a low-pressure side compressor stage.

15. The method according to claim 14,
wherein the liquid CO₂ is divided into two partial flows,
wherein a first partial flow (18a) is converted into solid CO₂ and gaseous CO₂, and
wherein a second partial flow (18b) is cooled through expansion to further cool down the first partial flow prior to conversion into solid CO₂ and gaseous CO₂.

16. The method according to claim 10, wherein for cleaning the at least one compressor stage at least one of:
dry ice obtained one of externally and outside the compression operation of the compressor is used for cleaning the respective compressor stage, and
carrier gas obtained one of externally and outside the compression operation of the compressor is used for cleaning the respective compressor stage.

17. The method according to claim 16, wherein for cleaning at least one compressor stage the dry ice and the carrier gas is used for cleaning the respective compressor stage.

18. The method according to claim 16, wherein for cleaning at least one compressor stage the dry ice obtained externally or outside the compression operation of the compressor and the carrier gas extracted one of from the compressed working medium internally and during the compression operation of the compressor is used for cleaning the respective compressor stage.

19. The method according to claim 14, wherein downstream of a high-pressure side compressor stage downstream of a last compressor stage the supercritically compressed CO₂ is initially liquefied.
